(19) United States
(12) Patent Application Publication
(10) Pub. No.: US 2024/0189947 A1
(43) Pub. Date: Jun. 13, 2024

(54) DEVICE FOR TRIMMING A DENTAL SPLINT

(71) Applicant: Dental Manufacturing Unit GmbH, Puch bei Hallein (AT)

(72) Inventors: Martin Huber, Pfarrwerfen (AT); Alfons Wörmer-Aigmüller, Bischofshofen (AT)

(21) Appl. No.: 18/286,360

(22) PCT Filed: Apr. 14, 2022
(86) PCT No.: PCT/AT2022/060118

§ 371 Date: Oct. 10, 2023

(30) Foreign Application Priority Data
May 4, 2021 (AT) A50342/2021

(51) Int. Cl. B23K 26/38; A61C 5/00

(52) U.S. Cl. CPC B23K 26/38; A61C 5/007

(57) ABSTRACT

A device for trimming a dental splint (1) comprises a spatially movable holder (2) for the dental splint (1), a suction device (3), a laser (4) and a computation unit (5). In a device of the aforementioned kind that can be used with a minimum of control complexity and preparation for the user to precisely trim dental splints despite the use of conventional components, the laser (4) is stationary, a camera (6) for determining the position of the dental splint (1) is provided, and the holder (2) comprises a platform (7) at least portions of which are thermostable and a stop (8) for the force-locked and play-free mounting of the dental splint (1), which is free from a deep-drawing mold.

### FIELD OF THE INVENTION

The invention relates to a device for trimming a dental splint, comprising a spatially movable holder for the dental splint, a suction device, a laser and a computation unit.

### DESCRIPTION OF THE PRIOR ART

Dental splints are known from the prior art which are produced from thermoforming sheets by means of a deep-drawing process. After the thermoforming sheet is pulled over a model of a denture, the dental splint must be trimmed. The free deep-drawing edge, i.e. the part of the thermoforming sheet that has not been formed by the model and does not form part of the dental splint, is separated from the dental splint and the resulting cutting line is deburred.

EP2101674B1 shows a device in which the dental splint is mounted on three columns which are located on a platform which can be spatially moved. The dental splint is fixed on the columns by means of negative pressure, whereupon it can subsequently be trimmed with a laser. For this purpose, an computation unit calculates the required cutting line of the laser on the basis of a CAD model of the dental splint and controls the platform and the movable laser in such a way that this cutting line is traced by the laser.

However, a disadvantage of the prior art is that the corresponding CAD model must always be created and loaded into the computation unit in order to trim a dental splint. Furthermore, both the parameters of the laser, such as the intensity or spatial alignment of the beam, and the position of the dental splint must be precisely known and precisely coordinated. In addition, the problem arises that parts of the deep-drawing edge already cut by the cutting process can suddenly hang down and cause the dental splint to slip. This results in cutting errors because the actual position of the dental splint deviates from the nominal position determined with the CAD model.

Although it has already been proposed (EP2760624B1) to mount the dental splint on a platform so that it rests over a large area with the free deep-drawing edge and is supported by the model of the denture, this requires even more complicated dynamic control of the laser intensity, since the intensity must be continuously adjusted to the local thickness of the thermoforming sheet so that the model of the denture is not welded to the thermoforming sheet by incorrectly adjusted laser intensity, or the device is damaged by the laser.

### SUMMARY OF THE INVENTION

The invention is thus based on the object of demonstrating a device which, despite the use of common components, enables precise trimming of dental splints with a minimum of control effort and preparation for the user.

The invention solves the object posed in that the laser is stationary, a camera for determining the position of the dental splint is provided, the holder comprises a platform at least portions of which are thermostable and a stop for the force-locked and play-free mounting of the dental splint, which is free from a deep-drawing mold. The dental splint, which is separated from the model of the denture, is mounted on the platform prior to trimming so that the free deep-drawing edge rests substantially flat on the platform. The stop fixes the dental splint over its free deep-drawing edge in a force-locked manner and without play, so that relative movement of the dental splint to the platform is prevented despite displacement of the holder. The camera records the position and shape of the dental splint mounted on the platform and the boundary area between the dental splint and the free deep-drawing edge in space. From this spatial data, the computation unit determines the cutting line for separating the dental splint from the free deep-drawing edge and consequently how the holder must be moved so that the laser beam follows the cutting line. The determination of the cutting line can also be repeated at any time during trimming with a new capture of the position data by the camera and an adapted cutting line can be determined. In addition, the use of the camera eliminates the need for position marking on the dental splint, which is necessary in the prior art. Since the laser is stationary, only the holder needs to be relocated to allow the laser to follow the cutting line. This results in fewer position inaccuracies and simplifies control. Laser intensity can be left unregulated during trimming because excess energy from the laser is absorbed by the thermostable platform. Laser intensity and platform material can be factory matched so that the laser intensity is sufficient to trim common dental splints, but too low to damage the platform. Since the required cutting lines of the dental splints essentially always extend only over the same partial area of the platform, the platform must be designed to be thermostable only in this partial area. The dental splint is trimmed without the model of the denture, which also means that the laser power does not have to be adjusted to protect the model. Surprisingly, it has been found that even when the free deep-drawing edge is completely separated from the dental splint, the dental splint is still stably supported by a frictional connection to the separated free deep-drawing edge. In a preferred embodiment, the platform is not only thermostable, but also thermally conductive, so that the excess laser energy can be diverted away from the dental splint and no heat build-up builds up in the platform, which heats up the dental splint. For this purpose, the platform can be made of anodized aluminum, for example. To determine the position of the dental splint and the required cutting line from the data of the camera, the computation unit can be equipped with self-learning algorithms or a neural network, which can be trained in particular to detect only the spatial position of the dental splint, the free deep-drawing edge and the border region between them and not to process other detailed image information. To determine the position, the holder with the dental splint can be moved to a capture position in which the camera captures an image of the dental splint. This capture position is selected with regard to the relative position of the holder to the camera in such a way that the camera used can, as far as possible without autofocus or other technical aids, capture a high-quality image of the dental splint and the surrounding deep-drawing edge, so that this image can be easily processed by the computation unit. For example, the dental splint may be oriented substantially transverse to the optical axis of the camera in the capture position. The processing steps of the image by the computation unit may include cropping, normalizing, and segmenting so that the computation unit can determine from the processed image the path of the required cutting lines. After the image has been normalized to the capture position, the surrounding deep-drawing edge can be detected by the computation unit via its pixel value, distinguished from the dental splint, and thus the required cutting line can be determined. Optionally, the computation unit can match the captured and processed image with a computer model of the dental splint. Reference points can also be determined in the capture position, on the basis of which the relative position of the dental splint can still be detected even after the holder has been relocated.

The computational effort required to determine the required cutting line can be reduced and the control of the holder can be simplified if the camera is arranged in the region of the laser. The closer the camera is located to the laser, the more similar the optical path of the laser and the camera are, so that the computation unit does not have to perform complex transformation steps to convert the data from the camera into commands for moving the holder. If the computation unit uses a neural network, this also facilitates the training of the same, since no complex transformation steps are required for the training images either, thus reducing the training time. In a preferred embodiment, the camera is an RGB camera, since the image quality of such a camera is high enough to produce reliable image data for further processing by the computation unit, despite its low cost.

The dental splint can be fixed even more firmly to the platform without further measures if the platform has at least one aperture that is fluid-connected to an inlet of the suction device, the inlet attached to the side of the platform facing away from the laser. As a result of these measures, the suction device not only extracts particles and/or vapors generated during trimming, but also applies a vacuum to the dental splint via the at least one aperture, which promotes adhesion of the dental splint to the platform. Since the required cutting lines of the dental splints essentially always extend only over the same partial area of the platform, in a preferred embodiment a plurality of apertures is arranged in this partial area, whereby particles and/or vapors are extracted where they arise and the dental splint is additionally fixed at its cut edges by the negative pressure. Since the laser beam can also pass through the apertures in the platform and strike the underlying part of the holder, thermally unstable parts of the holder must be arranged outside the beam path and/or the parts accessible to the laser beam must also be thermally stable. Although the platform can assume a plurality of relative positions to the laser due to its displaceability, for the purposes of the invention, the side of the platform that is facing away from the laser during processing of the dental splint is meant. In order to simplify trimming of the dental splint in addition to high local precision, it is proposed that the platform be displaceable at least in sections in five spatial directions. Thus, in addition to three translational movements, the holder, and thus the dental splint, can also perform rotations about two axes, allowing the cutting angle of the laser to be varied. This allows the cut edges of the dental splint to be reworked or abraded, thus improving the deburring of the dental splint.

During deep drawing, the free deep-drawing edge of the dental splint can deform, which can make it difficult to fix the dental splint on the platform. This can result in the dental splint not being able to be force-locked to the platform in any orientation, as it transfers the deformation from the free deep-drawing edge to the dental splint when the force-locking is established, possibly creating an incorrect cutting line. In order to enable accurate determination of the cutting line despite such deformations, the stop can be annular and form a receptacle with the platform for the free deep-drawing edge of the dental splint. As a result of these measures, the force-locked connection is established along the entire free deep-drawing edge and optionally supplemented by a positive connection. The dental splint can therefore be mounted on the platform via its free thermoforming sheet, regardless of the orientation of the dental splint, as long as the free thermoforming sheet lies flat on the platform. This allows frequently occurring wavy deformations at the free deep-drawing edge to be flattened. In a preferred embodiment, the stop is connected to the holder by a hinge and can be folded down and engaged before trimming.

The holder can be displaced easily and precisely if the holder comprises a cross slide. Due to its simple operating principle, the cross slide can be easily controlled via the adjustment spindles and does not require calibration. Furthermore, the holder can be rotated via one or more of the guides of the cross slide as well.

To create compact design conditions, the holder can comprise a turntable with which the at least sectionally thermostable platform is associated. This allows the dental splint with the platform to be relocated easily and in a space-saving manner without restricting accessibility for the laser. Particularly preferred design conditions result when the turntable is arranged on a cross slide.

### BRIEF DESCRIPTION OF THE INVENTION

In the drawings, the subject matter of the invention is shown by way of example, wherein:

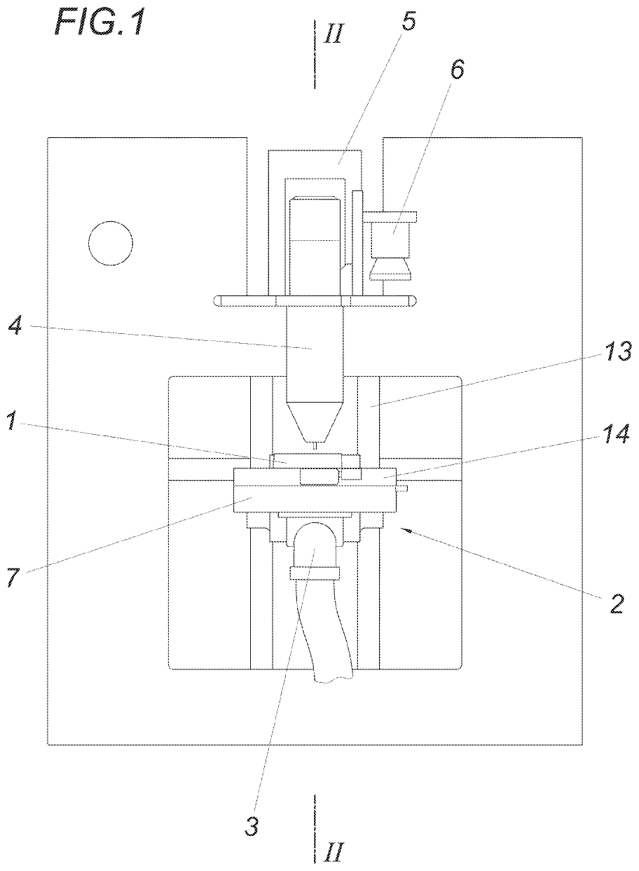

FIG. 1 shows a front view of a device according to the invention,

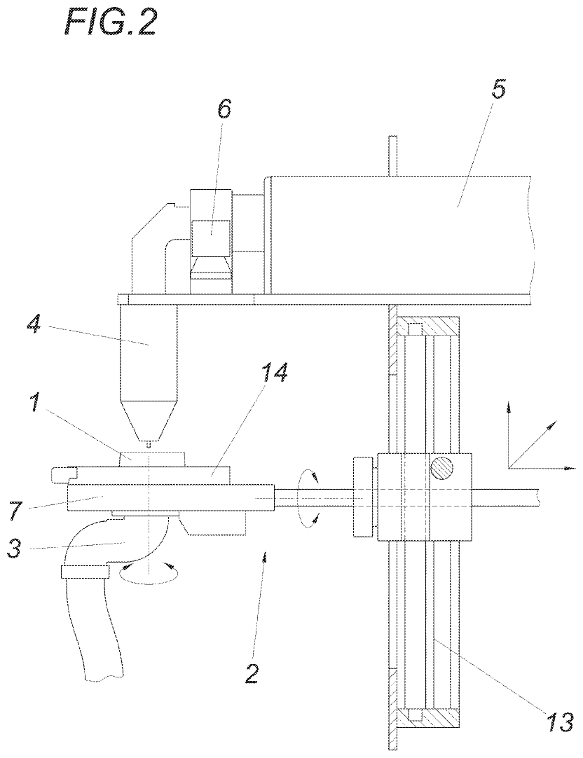

FIG. 2 shows a section along line II-II of FIG. 1,

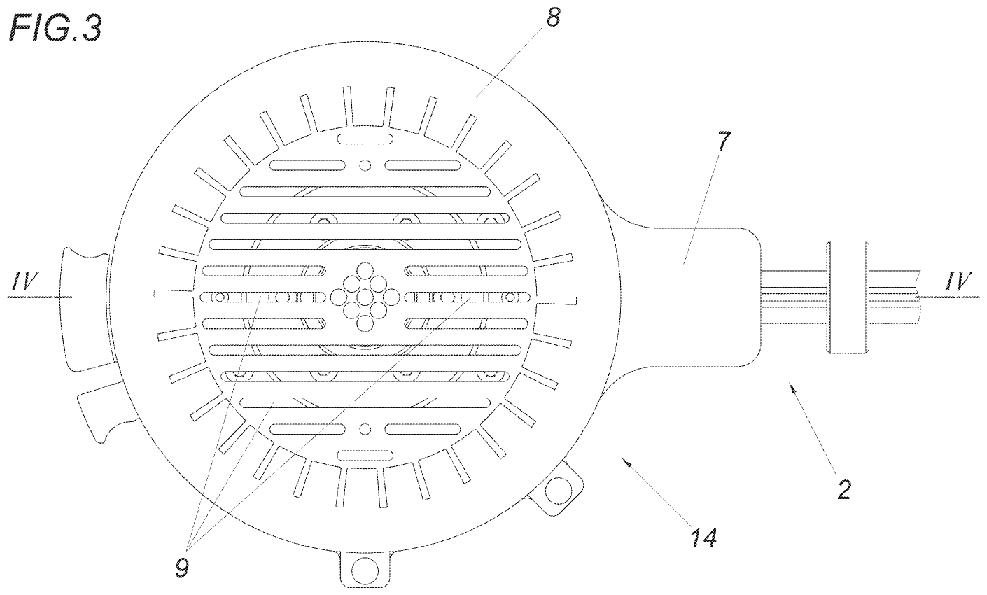

FIG. 3 shows a top view of a holder of a device according to the invention on a larger scale, and

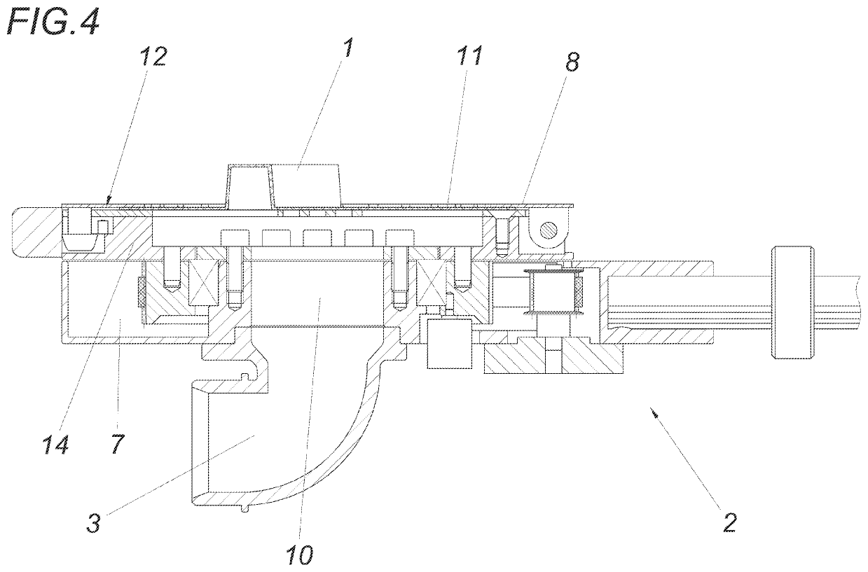

FIG. 4 shows a section along line IV-IV of FIG. 3.

### DETAILED DESCRIPTION OF THE PREFERRED EMBODIMENTS

A device according to the invention for trimming a dental splint 1 (shown only schematically) comprises a displaceable holder 2 for the dental splint 1 and a suction device 3 attached to the holder 2 for extracting particles and vapors generated by the trimming process. Furthermore, the device comprises a laser 4, an computation unit 5, which in the embodiment shown is mounted in the housing of the laser 4, and a camera 6. The holder 2 comprises a platform 7, which is thermostable at least in sections, on which the dental splint 1 can be mounted. Since the dental splint 1 is stored on the platform 7 for trimming without its associated deep-drawing model, the thermostable platform 7 must be able to absorb and preferably dissipate the excess energy of the laser beam of the laser 4 without damage. The laser 4 is of stationary design, which is why the platform 2 must be designed so that it can be displaced in several spatial directions, in a preferred embodiment in five spatial directions, in order to enable the trimming process for the laser 4. In order to ensure reliable mounting of the dental splint 1 on the platform 7 of the holder 2 in any position, the holder 2 therefore has a stop 8 for the dental splint 1, with which the latter can be mounted in a force-locked manner. In order to enable precise processing by the laser 4 in any position, the mounting of the dental splint 1 must be free of play.

The camera 6 supplies the necessary image data, on the basis of which the computation unit 5 determines the required cutting line for trimming the dental splint 1 and moves the holder 2 so that the laser beam can follow this required cutting line. The camera 6 is arranged in the region of the laser 4 so that the optical axes of the camera 6 and the laser 4 are also in the same region, which makes it easier for the computation unit 5 to determine the changes in position of the holder 2 required for trimming.

As can be seen in particular from FIG. 3, the platform 7 can comprise one or more apertures 9, and the suction device 3 can be connected to the holder 2 via an inlet 10 on the side of the platform 7 facing away from the dental splint 1. This makes it possible to establish a fluid connection between the inlet 10 and the at least one aperture 9, which makes it possible to extract the vapors to be extracted that are generated directly around the dental splint 1 during the trimming process by the laser 4 from the side of the platform 7 facing away from the dental splint 1. This increases the freedom of movement of the holder 2 and allows a shorter distance between the inlet 10 and the dental splint 1. This also facilitates the generation of a vacuum by the suction device 3, which further favors the support of the dental splint 1 on the platform 7.

If the stop 8 of the platform 7 is annular, the dental splint 1 can be supported on the periphery of the platform 7 via its free deep-drawing edge 11, whereby the play-free, friction-locked mounting of the dental splint 1 can be implemented independently of a change in position of the holder 2. In this case, the platform 7 with the stop 8 forms a receptacle 12 for the free deep-drawing edge 11 of the dental splint 1.

If the holder 2 comprises a cross slide 13 and a turntable 14 to which the at least sectionally thermostable platform 7 is assigned, the holder 2 can be relocated in an easily controllable, space-saving and cost-effective manner.

The five degrees of freedom of movement are shown in the coordinate system drawn in FIG. 2. In addition to three translational degrees of freedom, the platform 7 can be rotated at least in sections. This can be implemented, for example, via the turntable 14. A further degree of rotational freedom can be implemented, for example, by having a carriage of the cross slide 13 act as an axial support through which the longitudinal axis of the platform 7 is guided. As a result, the platform 7 can be displaced in the axial direction and is mounted so that it can rotate about the axis.

1. A device for trimming a dental splint, said device comprising:
a spatially movable holder configured to hold the dental splint, a suction device, a laser, and a computation unit,
wherein the laser is supported so as to be stationary in the device,
wherein a camera determines a position of the dental splint,
wherein the holder comprises
a platform at least portions of which are thermostable, and
a stop configured to provide force-locked and play-free mounting of the dental splint, wherein the dental splint is free from a deep-drawing mold.

2. The device according to claim 1, wherein the camera is supported in a region of the laser such that that the dental splint is oriented in a capture position transverse to an optical axis of the camera.

3. The device according to claim 1, wherein the platform has at least one aperture that is fluid-connected to an inlet of the suction device, wherein the inlet is attached to a side of the platform facing away from the laser.

4. The device according to claim 1, wherein the platform is displaceable at least in sections in five spatial directions.

5. The device according to claim 1, wherein the stop is annular and forms a receptacle with the platform that receives a free deep-drawing edge of the dental splint.

6. The device according to claim 1, wherein the holder comprises a cross slide.

7. The device according to claim 1, wherein the holder comprises a turntable with which the at least sectionally thermostable platform is associated.

8. The device according to claim 2, wherein the platform is displaceable at least in sections in five spatial directions.

9. The device according to claim 3, wherein the platform is displaceable at least in sections in five spatial directions.

10. The device according to claim 2, wherein the stop is annular and forms a receptacle with the platform that receives a free deep-drawing edge of the dental splint.

11. The device according to claim 3, wherein the stop is annular and forms a receptacle with the platform that receives a free deep-drawing edge of the dental splint.

12. The device according to claim 4, wherein the stop is annular and forms a receptacle with the platform that receives a free deep-drawing edge of the dental splint.

13. The device according to claim 8, wherein the stop is annular and forms a receptacle with the platform that receives a free deep-drawing edge of the dental splint.

14. The device according to claim 9, wherein the stop is annular and forms a receptacle with the platform that receives a free deep-drawing edge of the dental splint.

15. The device according to claim 4, wherein the holder comprises a turntable with which the at least sectionally thermostable platform is associated.

16. The device according to claim 2, wherein the holder comprises a turntable with which the at least sectionally thermostable platform is associated.

17. The device according to claim 3, wherein the holder comprises a turntable with which the at least sectionally thermostable platform is associated.

18. The device according to claim 4, wherein the holder comprises a turntable with which the at least sectionally thermostable platform is associated.

19. The device according to claim 5, wherein the holder comprises a turntable with which the at least sectionally thermostable platform is associated.

20. The device according to claim 6, wherein the holder comprises a turntable with which the at least sectionally thermostable platform is associated.
